(19) United States
(12) Patent Application Publication
(10) Pub. No.: US 2018/0150785 A1
(43) Pub. Date: May 31, 2018

(54) INTERACTION BASED MACHINE LEARNED VECTOR MODELLING

(71) Applicant: Linkedln Corporation, Sunnyvale, CA (US)

(72) Inventors: Jian Wang, Los Altos, CA (US); Krishnaram Kenthapadi, Sunnyvale, CA (US); David Hardtke, Oakland, CA (US)

(21) Appl. No.: 15/362,597

(22) Filed: Nov. 28, 2016

(51) Int. Cl. G06Q 10/06; G06N 99/00; G06Q 50/00

(52) U.S. Cl. CPC G06Q 10/063112; G06Q 50/01; G06N 99/005

(57) ABSTRACT

Apparatuses, computer readable media, and methods are disclosed for generating machine learned models and recommendations identified using hidden feature vectors determined using the machine learned models. The method includes selecting a job profile associated with a first set of members of a social networking system. The method identifies a set of interactions with the job profile, where the set of actions are taken by a second set of members, and generates a vector model for the job profile. The vector model identifies a set of hidden feature vectors for the job profile. The method determines a job recommendation based on the job profile, the set of interactions, the set of second members, and the vector profile. The method then causes presentation of the job recommendation on a display device of a computing device.

### TECHNICAL FIELD

The subject matter disclosed herein generally relates to the technical field of special-purpose machines that facilitate machine learning techniques for vector modelling within a network service, including software-configured computerized variants of such special-purpose machines and improvements to such variants, and to the technologies by which such special-purpose machines become improved compared to other special-purpose machines that facilitate generating machine learned vector models to identify latent vectors within a database and generate recommendations using the latent vectors.

### BACKGROUND

Many data retrieval systems, such as social networking and search systems, employ content based models to surface search results and retrieve content stored on the data retrieval system for recommendations. Some systems use structured fields for data storage and categorization of content to enable recall of documents by content based recall models. The structured fields are often incorporated into the content based models within a static feature space. These content based models are based primarily on explicit user context and fail to incorporate implicit user context. Display of inaccurate or unsuitable matches or results due to incomplete context discourages users from engaging with the data retrieval system. Further, content based models become computationally demanding where the data retrieval system includes large numbers of data elements to potentially be compared, parsed, and selected for inclusion within a set of results.

### DESCRIPTION OF THE DRAWINGS

Some embodiments are illustrated by way of example and not limitation in the FIGS. of the accompanying drawings, in which:

FIG. 1 is a block diagram of a social network system, in accordance with some embodiments;

FIG. 2 illustrates a job recommendation engine, in accordance with some embodiments;

FIG. 3 illustrates the interaction component, in accordance with some embodiments;

FIG. 4 illustrates a method for generating job recommendations, in accordance with some embodiments;

FIG. 5 illustrates a method for generating job recommendations, in accordance with some embodiments;

FIG. 6 illustrates a method for generating job recommendations, in accordance with some embodiments;

FIG. 7 illustrates a method for generating job recommendations, in accordance with some embodiments;

FIG. 8 illustrates a method for generating job recommendations, in accordance with some embodiments; and

FIG. 9 shows a diagrammatic representation of the machine in the example form of a computer system and within which instructions (e.g., software) for causing the machine to perform any one or more of the methodologies discussed herein may be executed.

### DETAILED DESCRIPTION

The present disclosure describes methods, systems and computer program products for improving the generating job recommendations. In the following description, for purposes of explanation, numerous specific details are set forth in order to provide a thorough understanding of the various aspects of different embodiments of the present invention. It will be evident, however, to one skilled in the art, that the present disclosure may be practiced without all of the specific details and/or with variations permutations and combinations of the various features and elements described herein.

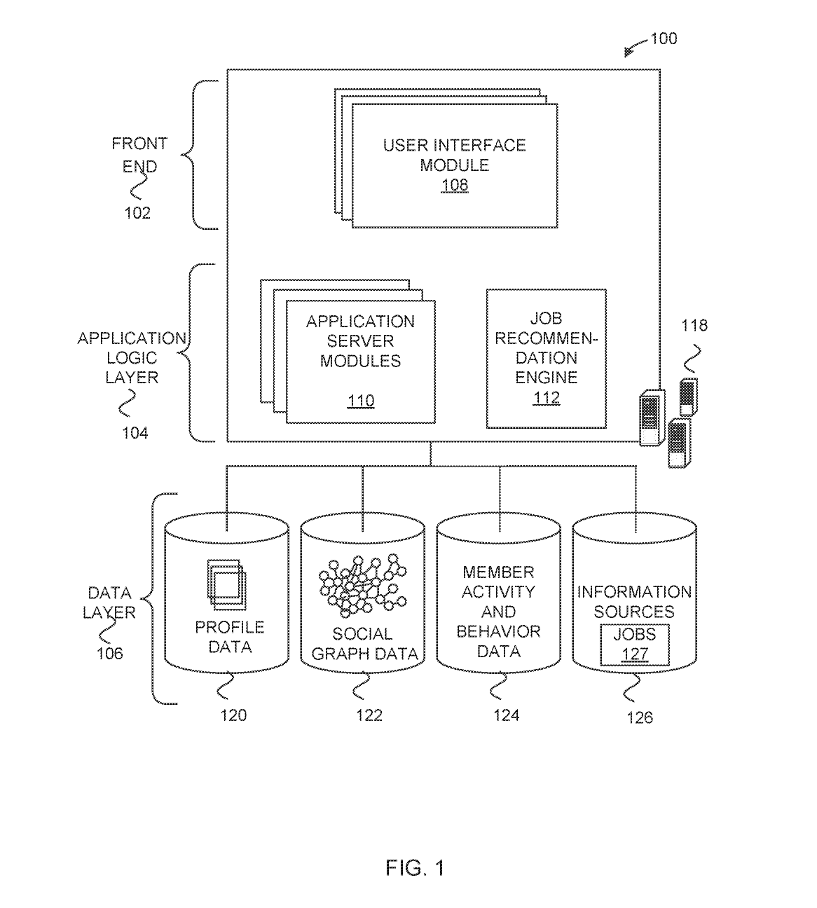

FIG. 1 is a block diagram of a social network system 100, in accordance with some embodiments. The social network system 100 may be based on a three-tiered architecture, comprising a front-end layer 102, application logic layer 104, and data layer 106. Some embodiments implement the social network system 100 using different architectures. The social network system 100 may be implemented on one or more computers 118. The computers 118 may be servers, personal computers, laptops, portable devices, etc. The social network system 100 may be implemented in a combination of software, hardware, and firmware.

As shown in FIG. 1, the front end 102 includes user interface modules 108. The user interface modules 108 may be one or more web services. The user interface modules 108 receive requests from various client-computing devices, and communicate appropriate responses to the requesting client devices. For example, the user interface modules 108 may receive requests in the form of Hypertext Transport Protocol (HTTP) requests, or other web-based, application programming interface (API) requests. The client devices (not shown) may be executing web browser applications, or applications that have been developed for a specific platform to include any of a wide variety of mobile devices and operating systems.

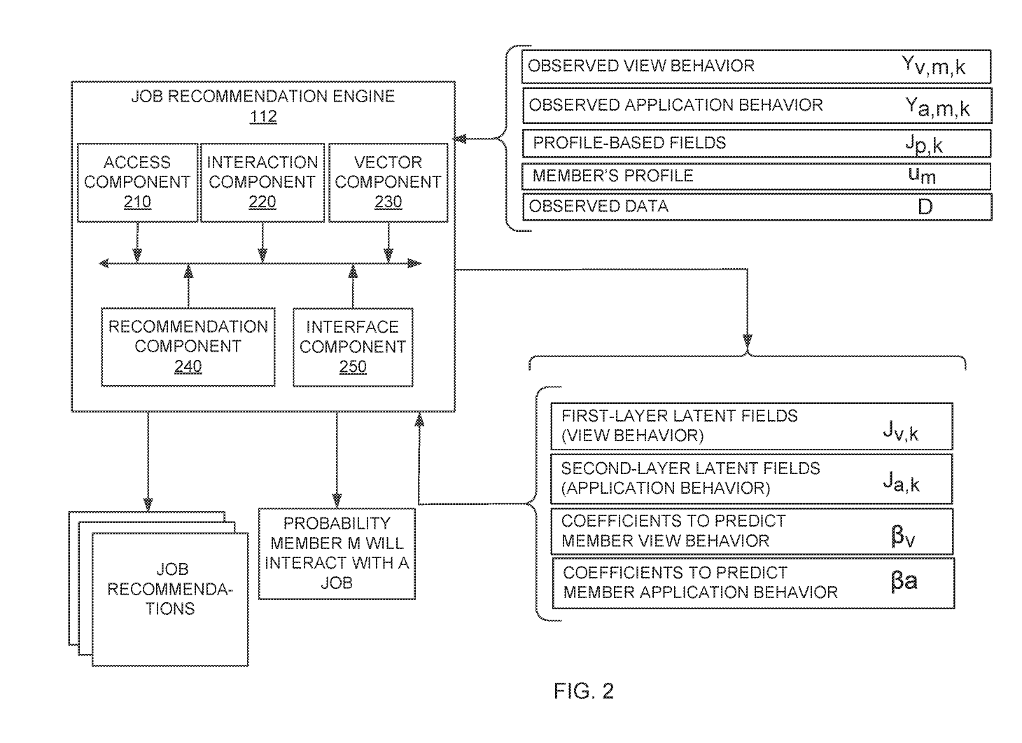

As shown in FIG. 1, the data layer 106 includes profile data 120, social graph data 122, member activity and behavior data 124, and information sources 126. Profile data 120, social graph data 122, and member activity and behavior data 124, and/or information sources 126 may be databases. One or more of the data layer 106 may store data relating to various entities represented in a social graph. In some embodiments, these entities include members, companies, and/or educational institutions, among possible others. Consistent with some embodiments, when a person initially registers to become a member of the social network system 100, and at various times subsequent to initially registering, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, and so on. This information is stored as part of a member's member profile, for example, in profile data 120. The profile data 120 may include a vector of fields associated with the member m. The fields of the vector of fields may represent attributes of the member's profile. The attributes may comprise demographic information, interests, contact information, skills, educational background, job titles (e.g., current and former), industry information, and other suitable information provided by the member or gleaned from the information provided by the member. The vector of fields (e.g., the member's profile) may be represented as uₘ (see FIG. 2).

With some embodiments, a member's profile data 120 will include not only the explicitly provided data, but also any number of derived or computed member profile attributes and/or characteristic, which may become part of one of more of profile data 120, social graph data 122, member activity and behavior data 124, and/or information sources 126. The derived member profile attributes may be included in the representation, uₘ, of the member's profile. Table 1 is an example of member's profile uₘ fields.

TABLE 1
EXAMPLE MEMBER PROFILE FIELDS

<sourceField entityType=“MEMBER” name=“associations”>
<sourceField entityType=“MEMBER” name=“current functions”>
<sourceField entityType=“MEMBER” name=“current normalized title
seniority years”/>
<sourceField entityType=“MEMBER” name=“current position
summary”>
<sourceField entityType=“MEMBER” name=“current title short form”>
<sourceField entityType=“MEMBER” name=“current title string”>
<sourceField entityType=“MEMBER” name=“current title”>
<sourceField entityType=“MEMBER” name=“current company name”>
<sourceField entityType=“MEMBER” name=“Custom plus latent
preferences with regard to location”>
<sourceField entityType=“MEMBER” name=“custom plus latent
preferences with regard to senority”>
<sourceField entityType=“MEMBER” name=“degrees”>
<sourceField entityType=“MEMBER” name=“education notes”>
<sourceField entiryType=“MEMBER” name=“headline”>
<sourceField entityType=“MEMBER” name=“honors”>
<sourceField entityType=“MEMBER” name=“interests”>
<sourceField entityType=“MEMBER” name=“job seniority previous
jobs”>
<sourceField entityType=“MEMBER” name=“past functions”>
<sourceField entityType=“MEMBER” name=“past position summary”>
<sourceField entityType=“MEMBER” name=“past title string”>
<sourceField entityType=“MEMBER” name=“past titles”>
<sourceField entityType=“MEMBER” name=“location”>
<sourceField entityType=“MEMBER” name=“preferences company
size”/>
<sourceField entityType=“MEMBER” name=“preferences industry
category”/>
<sourceField entityType=“MEMBER” name=“preferences location”/>
<sourceField entityType=“MEMBER” name=“preferences seniority”/>
<sourceField entityType=“MEMBER” name=“resolved company size”>
<sourceField entityType=“MEMBER” name=“resolved country”/>
<sourceField entityType=“MEMBER” name=“resolved industry
category”>
<sourceField entityType=“MEMBER” name=“standardized skills as
string”>
<sourceField entityType=“MEMBER” name=“standardized skills”>
<sourceField entityType=“MEMBER” name=“summary”>

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a “connection”, the concept of “following” another member typically is a unilateral operation, and at least with some embodiments, does not require acknowledgement or approval by the member that is being followed. When one member follows another, the member who is following may receive automatic notifications about various activities undertaken by the member being followed. In addition to following another member, a user may elect to follow a company, a topic, a conversation, or some other entity. In general, the associations and relationships that a member has with other members and other entities (e.g., companies, schools, etc.) become part of the social graph data 122. With some embodiments, the social graph data 122 may be implemented with a graph database, which is a particular type of database that uses graph structures with nodes, edges, and properties to represent and store data. In this case, the social graph data 122 reflects the various entities that are part of the social graph, as well as how those entities are related with one another.

With various alternative embodiments, any number of other entities might be included in the social graph data 122, and as such, various other databases may be used to store data corresponding with other entities. For example, although not shown in FIG. 1, consistent with some embodiments, the system may include additional databases for storing information relating to a wide variety of entities, such as information concerning various online or offline people, job announcements, companies, groups, posts, slideshares, and so forth.

With some embodiments, the application server modules 110 may include one or more activity and/or event tracking modules, which generally detect various user-related activities and/or events, and then store information relating to those activities/events in, for example, member activity and behavior data 124. For example, the tracking modules may identify when a user makes a change to some attribute of his or her member profile, or adds a new attribute. Additionally, a tracking module may detect the interactions that a member has with different types of content. For example, a tracking module may track a member's activity with respect to job announcements or job profiles, e.g. job announcement or profile views, saving of job announcements or profiles, applications to a job in a job announcement or profile, explicit feedback regarding a job announcement or profile (e.g., not interested, not looking, too junior, not qualified, information regarding the job the member would like, a location member wants to work, do not want to move, more like this, etc.), job search terms that may be entered by a member to search for job announcements or job profiles. Such information may be used, for example, by one or more recommendation engines to generate vector models for job profiles, tailor the content presented to a particular member, and generally to tailor the user experience for a particular member.

Information sources 126 may be one or more additional information sources. For example, information sources 126 may include ranking and business rules, historical search data, and reference data as well as people, jobs 127, which may include one or more job profiles, job announcements (not illustrated), etc. The one or more job profiles comprise job profile data for each job represented within the social network system 100. The job profile data may include a job profile, an observed viewing behavior of users for a job k, y_{v,m,k}; an observed application behavior of users for the job k, y_{a,m,k}, a vector of first-layer latent fields associated with viewing behavior of users for the job k, j_{v,k}; a vector of second-layer latent fields associated with application behavior of users for the job k, j_{a,k}; coefficients to predict user viewing behavior for the job k, βᵥ; and coefficients to predict user application behavior for the job k, βₐ. The observed viewing behavior of users for a job k, y_{v,m,k}, may indicate a member viewed a job profile or announcement for a job k where y_{v,m,k}=1. Where the member has not viewed the job profile or job announcement for the job k, y_{v,m,k}=−1. The observed application behavior of users for the job k, y_{a,m,k}, may indicate a member applied to a job announcement or job profile for the job km where y_{a,m,k}=1. Where the member has not applied to a job announcement or job profile for the job k, y_{a,m,k}=−1. In some embodiments, as described above, with respect to member profiles, the job profile includes any number of derived or computed job profile attributes or characteristics. These calculated attributes or characteristics become part of the job profile data. An example of derived or calculated attributes or characteristics is a vector of profile-based fields associated with the job j_{p,k}.

In some embodiments, the job profile j_{p,k} is vector fields or features associated with job k of jobs 127. The vector includes static features that are derived from the job description, e.g. job title, qualifications, job location, etc. The job profile j_{p,k} may be stored in information sources 126. The job profile j_{p,k} is a profile of a job 127, which, in some embodiments, has one or more job announcements or postings associated with the job profile j_{p,k} or job 127. Table 2 illustrates example fields of the job profile j_{p,k}.

TABLE 2
EXAMPLE JOB PROFILE FIELDS

<targetField entityType=“JOB” name=“listing type”/>
<targetField entityType=“JOB” name=“job seniority”/>
<targetField entityType=“JOB” name=“industry category”/>
<targetField entityType=“JOB” name=“company size”/>
<targetField entityType=“JOB” name=“company locations”/>
<targetField entityType=“JOB” name=“job opening locations”/>
<targetField entityType=“JOB” name=“job seniority minimum”/>
<targetField entityType=“JOB” name=“geographical country”/>
<targetField entityType=“JOB” name=“skills”>
<targetField entityType=“JOB” name=“description of job”>
<targetField entityType=“JOB” name=“company Description”>
<targetField entityType=“JOB” name=“functions to be performed”>
<targetField entityType=“JOB” name=“job seniority preferred”>
<targetField entityType=“JOB” name=“standardized skills required”>
<targetField entityType=“JOB” name=“relevant standardized skills”>
<targetField entityType=“JOB” name=“job title”>
<targetField entityType=“JOB” name=“job title as a string”>
<targetField entityType=“JOB” name=“industry category”>

In some embodiments, observed data D is observed data of all jobs k, e.g., D={D₁, . . . , Dₖ, . . . . , D_{K}}. The observed data D is stored in the member activity and behavior data 124 or in information sources 126, in accordance with some embodiments. In some embodiments, Dₖ={y_{v,m,k}, y_{a,m,k}, uₘ, j_{p,k}} is a set of observed data associated with job k. Each observation is associated with four parts: view behavior of users for job k y_{v,m,k}, application behavior for users to job k y_{a,m,k}, member's profile uₘ, and profile-based fields j_{p,k}. In some embodiments, the Dₘ is stored in the member activity and behavior data 124 or in the information sources 126.

The application server modules 110, which, in conjunction with the user interface module 108, generate various user interfaces (e.g., web pages) with data retrieved from the data layer 106. In some embodiments, individual application server modules 110 are used to implement the functionality associated with various applications, services and features of the social network service. For instance, a messaging application, such as an email application, an instant messaging application, or some hybrid or variation of the two, may be implemented with one or more application server modules 110. Of course, other applications or services may be separately embodied in their own application server modules 110. In some embodiments, applications may be implemented with a combination of application server modules 110 and user interface modules 108. For example, a job recommendation engine 112 may be implemented with a combination of back-end modules, front-end modules, and modules that reside on a user's computer 118. For example, the social network system 100 may download a module to a web browser running on a user's computer 118, which may communicate with a module running on a server 118 which may communicate with a module running on a back-end database server 118.

The social network system 100 may provide a broad range of applications and services that allow members the opportunity to share and receive information, often customized to the interests of the member. For example, with some embodiments, the social network system 100 may include a photo sharing application that allows members to upload and share photos with other members. As such, at least with some embodiments, a photograph may be a property or entity included within a social graph. With some embodiments, members of a social network service may be able to self-organize into groups, or interest groups, organized around a subject matter or topic of interest. Accordingly, the data for a group may be stored in social graph data 122. When a member joins a group, his or her membership in the group may be reflected in the social graph data 122, a member's profile uₘ, a job profile j_{p,k}, and a feature vector associated with both a member profile and the job x_{m,k}. In some instances, the feature vector associated with the member profile and the job k, x_{m,k}, includes user fields urn, job profile fields j_{p,k}, and similarity-based features between the user fields and the job profile-based fields. In some embodiments, members may subscribe to or join groups affiliated with one or more companies. For instance, with some embodiments, members of the social network service may indicate an affiliation with a company at which they are employed, such that news and events pertaining to the company are automatically communicated to the members. With some embodiments, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the social graph and structured with the social graph data 122 and may be reflected in the a member's profile uₘ, the job profile j_{p,k}, and the feature vector associated with both a member profile and the job x_{m,k}.

In addition to the various application server modules 110, the application logic layer 104 includes a job recommendation engine 112. As illustrated in FIG. 1, with some embodiments, the job recommendation engine 112 is implemented as a service that operates in conjunction with various application server modules 110 and user interface modules 108. For instance, any number of individual application server modules 110 can invoke the functionality of the job recommendation engine 112. However, with various alternative embodiments, the job recommendation engine 112 may be implemented as its own application server module 110 such that it operates as a stand-alone application.

The job recommendation engine 112 may search the data layer 106 and determine jobs 127 to present to a member. In some embodiments, the job recommendation engine 112 may determine jobs 127 that should not be presented to a member. In some embodiments, the job recommendation engine 112 works offline to prepare jobs 127 to present to a member. In some embodiments, the job recommendation engine 112 may be used by a recruiter to generate a list of members that may be interested in a particular job 127. The recruiter may pay to push the job 127 to the member or members.

In some example embodiments, the job recommendation engine 112 includes or has an associated publicly available application programming interface (API) that enables third-party applications to invoke the functionality of the job recommendation engine 112.

As is understood by skilled artisans in the relevant computer and Internet-related arts, each engine shown in FIG. 1 represents a set of executable software instructions and the corresponding hardware (e.g., memory and processor) for executing the instructions. To avoid obscuring the disclosed embodiments with unnecessary detail, various functional modules and engines that are not germane to conveying an understanding of the inventive subject matter have been omitted from FIG. 1. However, a skilled artisan will readily recognize that various additional functional modules and engines may be used with a social network system 100, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the disclosed embodiments are by no means limited to such architecture.

FIG. 2 illustrates a job recommendation engine 112, in accordance with some embodiments. In some example embodiments, the job recommendation engine 112 comprises an access component 210, an interaction component 220, a vector component 230, a recommendation component 240, and an interface component 250. All, or some, of the components 210-250 communicate with each other, for example, via a network coupling, shared memory, and the like. Each component of components 210-250 can be implemented as a single component, combined into other components, or further subdivided into multiple components. Other components not pertinent to example embodiments can also be included, but are not shown.

The access component 210 selects, accesses, or otherwise receives job profile information from the social network system 100. In some example embodiments, the access component 210 selects the job profile in coordination with one or more other components. For example, in some instances, the access component 210 selects the job profile in response to receiving a user interface selection from the interface component 250 indicating selection of a user interface element by a user of a computing device. The selection of the user interface element may indicate a desire to access, view, share, or otherwise interact with the job profile. In some instances, after selecting the job profile, the access component 210 transmits the job profile, or an indication thereof, to one or more other components of the job recommendation engine 112. In some embodiments, the access component 210 passes an indication of the selected job profile to one or more of the interaction component 220 and the vector component 230.

The interaction component 220 identifies sets of interactions with job profiles on the social network system 100. In some embodiments, the interaction component 220 determines or cooperates with another component to determine selections or other interactions and behaviors indicating a desire to access, view, share, apply, or otherwise interact with the job profiles of the social networking system 100. The interaction component 220 may identify sets of interactions by accessing job profiles within the information sources 126, member behavior, actions, preferences, and the like stored within the behavior data 124 of the social networking system 100. In some instances, the interaction component 220 identifies actions or behaviors according to a hierarchical organization of levels of actions or activities. In these embodiments, the actions or behaviors may be organized hierarchically based on a level of interaction with a job profile. For example, a first-level interaction may be viewing of a job profile while a second-level interaction may comprise applying to a job announcement or job profile. In these example embodiments, the second-level interactions comprise a higher hierarchical level and may be provided an increased weight for generating vector models. Although described with respect to two hierarchical levels, it should be understood that the hierarchical activity organization may include any number of suitable levels to delineate types of actions, and weights associated with each level to tune an importance of each level within generated vector models. For example, in some embodiments, the hierarchical activity organization comprises distinct levels of activity for actions comprising searching behavior, viewing behavior, sharing behavior, recommendation behavior, application behavior, current or former employment (e.g., being currently or formerly employed at a job corresponding to the job profile), or other suitable activities as evidenced by one or more of the member's profile and member activities and behavior.

The vector component 230 generates vector models for job profiles of the social networking system 100. In some embodiments, the vector component 230 identifies hidden feature vectors for job profiles of the social network system 100. In some embodiments, hidden feature vectors represent elements, attributes, or other aspects common to member profiles associated with the job profile or which have interacted with the job profile. In some instances, the vector component 230 generates a vector model for a job profile using one or more equations interpreting and analyzing two or more job profiles and behaviors or activities associated with one or more member profiles interacting with one or more of the two or more job profiles.

In some example embodiments, the vector component 230 uses one or more equations to determine model parameters for a vector model. A first sub-component specifies parameter likelihoods in the vector model. In some embodiments, the parameter comprises a coefficient to predict user viewing behavior for a job 127, βᵥ (e.g., a first coefficient) and a coefficient to predict user application behavior for the job 127 βₐ (e.g., a second coefficient). The first coefficient βᵥ and the second coefficient βₐ may be coefficients for a regression model (e.g., the vector model). In some embodiments, the first sub-component determines parameters comprising a first variance coefficient σᵥ and a second variance coefficient σₐ. The first variance coefficient controls the distribution from which first-layer latent fields (e.g., view-based latent features) for the job are drawn. The second variance coefficient controls the distribution from which second-layer latent fields (e.g., application-based latent features) are drawn. The first-layer latent fields may be represented as the vector of first-layer latent fields associated with the job 127, j_{v,k}. The second-layer latent fields may be represented as the vector of second-layer latent fields associated with the job 127, j_{a,k}. In some example embodiments, the first sub-component determines the first coefficient and the first variance coefficient jointly (e.g., first regression coefficients), and determines the second coefficient and the second variance coefficient jointly (e.g., second regression coefficients). In some instances, the first sub-component determines the first coefficient, the second coefficient, the first variance coefficient, and the second variance coefficient jointly. The parameters may be sampled from a Gaussian distribution.

In some example embodiments, the first sub-component uses equations (1a), (1b), (1c), and (1d) to determine the first coefficient, the second coefficient, the first variance coefficient, and the second variance coefficient.

βᵥ˜N(μ_{βv},σ_{βv}) Equation (1a):

βₐ˜N(μ_{βa},σ_{βa}) Equation (1b):

σᵥ˜N(μ_{σv},σ_{σv}) Equation (1c):

σₐ˜N(μ_{σa},σ_{σa}) Equation (1d):

In some instances, the equations (1a), (1b), (1c), and (1d) may be denoted as ϕ=(μ_{βv}, σ_{βv}, μ_{βa}, σ_{βa}, μ_{σv}, σ_{σv}, μ_{σa}, σ_{σa}).

In some example embodiments, the vector component 230 uses one or more equations to determine job feature vectors for the vector model. Lowercase M is used to indicate the index of the member for 1, 2, . . . , M members. Lowercase K is used to indicate the index of the job for 1, 2, . . . , N jobs. A second sub-component specifies likelihoods of the job feature vectors. The second sub-component extracts the profile based fields j_{p,k} from a static job profile for which the vector model is being generated. The second sub-component then identifies the first-layer latent fields j_{v,k}, and the second-layer latent fields j_{a,k}. The first-layer latent fields j_{v,k} may follow a Gaussian distribution with the profile based fields j_{p,k} as a mean and having a variance according to the first variance coefficient σᵥ. The second-layer latent fields may follow the Gaussian distribution with the profile based fields j_{p,k} as a mean and having a variance according to the second variance coefficient σₐ. In these embodiments, the second sub-component uses Equations (2a) and (2b) to determine the first-layer latent fields and the second-layer latent fields.

j_{v,k}˜N(j_{p,k},σᵥ) Equation (2a):

j_{a,k}˜N(j_{v,k},σₐ) Equation (2b):

In some instances, a higher value for the first variance coefficient σᵥ indicates less important profile based fields j_{p,k}. This may cause the vector model to give more weight to view-based interactions with the job profile than the fields of the job profile for which the vector model is being generated. The first variance coefficient σᵥ and the second variance coefficient σₐ may be tuned manually to control a weight of the fields received from the profile based fields j_{p,k}. In some example embodiments, the first variance coefficient σᵥ and the second variance coefficient σₐ are tuned automatically by the vector component 230. In some instances of the example embodiments referenced above, the vector component 230 automatically tunes the first variance coefficient σᵥ and the second variance coefficient σₐ iteratively. As will be explained in more detail below, the iterative tuning of the first variance coefficient σᵥ and the second variance coefficient σₐ may be performed in combination or in coordination with automated iterative tuning of one or more of the first regression coefficients and the second regression coefficients. In these instances, the first sub-component and the second sub-component operated in coordination with one another to generate and tune the vector model.

In some example embodiments, using the first regression coefficients, the second regression coefficients, and the first-layer latent fields, the vector component 230 generates a list of features (e.g., hidden feature vectors) for the job profile. In some instances, the vector component 230 generates the output of features as the first-layer latent fields j_{v,k}, and the second-layer latent fields j_{a,k}. In some instances, the second-layer latent fields j_{a,k} are provided as the output of hidden feature vectors for the job profile. The hidden feature vectors may be generated using the above equations and represent similarity comparisons of the job profile, one or more similar job profiles, one or more member profiles of members viewing the job profile or similar job profiles, and one or more member profiles of members applying to the job profile or similar job profiles. In some example embodiments, the vector component 230 identifies the first-layer latent fields j_{v,k}, using Equation 3 and the second-layer latent fields j_{a,k} using Equation 4.

p(y_{v,m,k}|j_{v,k},βᵥ)=1/(1+exp(−y_{v,m,k}(βᵥ^{T}f(j_{v,k},uₘ)))) Equation 3:

p(y_{a,m,k}|j_{a,k},βₐ)=1/(1+exp(−y_{a,m,k}(βₐ^{T}f(j_{a,k},uₘ)))) Equation 4:

Equations 3 and 4 specify a likelihood of observed interaction between members and the job profile. In some instances, using Equation 3, the members determined to be likely to interact at a first-level (e.g., view) the job profile depends on the first-layer latent fields j_{v,k} and the first coefficient βᵥ (e.g., a vector model, regression model, or portion of a vector or regression model associated with the first coefficient). In some instances, using Equation 4, the members determined to be likely to interact at a second-level with (e.g., apply to) the job profile depends on the second-layer latent fields j_{a,k} and the second coefficient βₐ (e.g., a vector model, regression model, or portion of a vector or regression model associated with the second coefficient).

In some example embodiments, the job recommendation engine 112 or the vector component 230 assumes the data is independently and identically distributed. In these instances, the vector component 230 represents the data likelihood using Equation 5.

$$\begin{matrix}p ( D \vert φ ) = \int p ( D , {θ}_{g} \vert φ ) d {θ}_{g} \\ = \int p ( D \vert {θ}_{g} , φ ) p ( {θ}_{g} \vert φ ) d {θ}_{g} \\ = \int [ {\prod }_{k = 1}^{M} p ( {y}_{k} \vert {θ}_{g} , φ ) ] p ( {θ}_{g} \vert φ ) d {θ}_{g}\end{matrix} \qquad Equation 5$$

As shown, in Equation 5, θ_{g} is equal to (βₐ, βᵥ, σₐ, σᵥ). Further, θ_{g} may be a random variable denoting joint distribution of the global random variables, βₐ, βᵥ, σₐ, and σᵥ.

In some instances, the job recommendation engine 112 or the vector component 230 determines the data likelihood for job k (e.g., the job profile for which the vector model was generated) using Equation 6.

p(yₖ|θ_{g},ϕ)=∫p(yₖ|θₖ,θ_{g},ϕ)*p(θₖ|θ_{g},ϕ)dθₖ Equation 6:

As shown, in Equation 6, p(yₖ|θₖ, θ_{g}, ϕ)*p(θₖ|θ_{g}, ϕ)=Πₘ₌₁^{M}^{ₖ}[p(y_{v,m,k}|j_{v,k},βᵥ)*p(y_{a,m,k}|j_{a,k}, βₐ)]*p(j_{a,k}|j_{v,k}, σₐ)p(j_{v,k}|σᵥ). In these instances, σₖ=(j_{v,k}, j_{a,k}). Further, Ok may be a random variable denoting joint distribution of the first-layer latent vector and the second-layer latent vector for the job k (e.g., the job profile for which the vector model was generated). For example, the random variable may denote joint distribution of the view-based vector and the application-based vector for each job k.

In some embodiments, the vector component 230 maximizes (e.g., determines a theoretical maximum for) a likelihood of p(D, ϕ). In some instances, maximizing the likelihood of p(D, ϕ) is equivalent to maximizing a log likelihood of Equation 7.

L(D|ϕ)=ln p(D|ϕ) Equation 7:

The vector component 230 may not use a closed-form solution for estimation of model parameters in the above described equations. In some embodiments, the vector component 230 generates an approximate solution using an iterative process. In some instances, the vector component 230 uses a Bayesian method in the iterative process. The vector component 230 thereby derives an expectation-maximization (EM) based iterative process to approximate the solution. In these instances, the expectation (E) operation or set of operations holds constant (e.g., retains a fixed value) for the regression structures (e.g., first regression coefficients and second regression coefficients) described above and the latent vectors are varied (e.g., iterated or tuned). In the maximization (M) operation or set of operations, the vector component 230 holds constant (e.g., retains a fixed value) for the latent vectors and varies the regression structures described above. As described below, in some embodiments, the job recommendation engine 112, using one or more of the components, determines the first regression coefficients, the second regression coefficients, the first-layer latent vectors, and the second-layer latent vectors using the iteration process to generate a tuned vector model using Equation 6. The job recommendation engine 112, using the tuned vector model, may be used to identify attributes of members likely to interact with a job profile, using the hidden feature vectors as the attributes. In some embodiments, the job recommendation engine 112 uses the vector model to determine a probability that a member M will view or apply to a specified job.

The recommendation component 240 determined job recommendations for a specified member of the social network system 100 based on one or more of a set of job profiles, a set of vector models, and a set of member profiles. The recommendation component 240 receives or otherwise accesses hidden feature vectors identified by the vector component 230 during generation and tuning of the vector model for the set of job profiles. The recommendation component 240 compares aspects, attributes, characteristics, or fields of a member profile of the specified member to the hidden feature vectors. In some embodiments, the recommendation component 240 determines a single job for inclusion in a job recommendation. In some instances, the recommendation component 240 determines a set of jobs for inclusion in a job recommendation and an order or rank for the set of jobs.

The interface component 250 causes presentation of the job recommendation on a display device of a computing device of the selected or specified member. In some embodiments, the interface component 250 causes presentation of the job recommendation by transmitting user interface data to the computing device. The user interface data may be configured to cause the computing device to depict the job recommendation on a display device associated with the computing device.

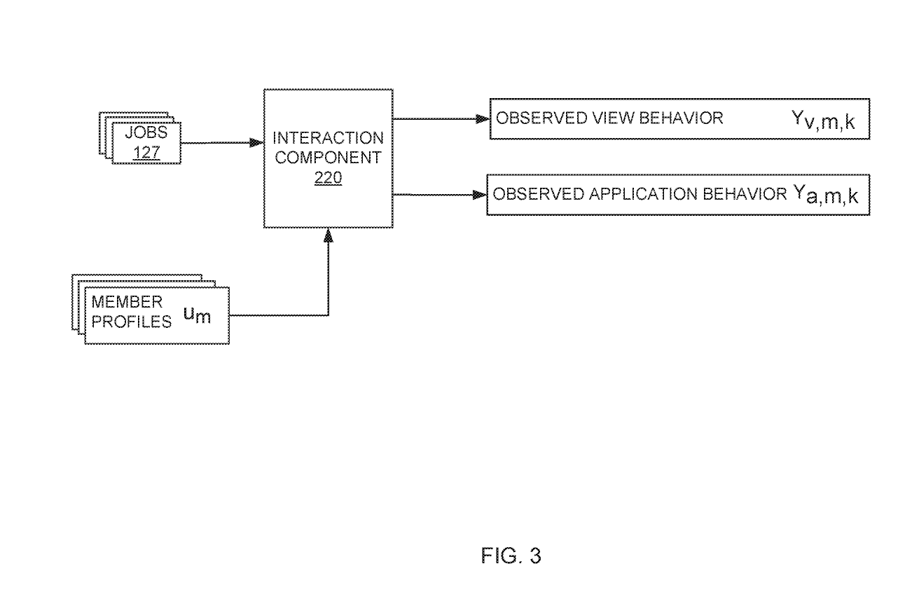

FIG. 3 illustrates the interaction component 220, in accordance with some embodiments. Illustrated in FIG. 3 is jobs 127, the interaction component 220, member's profile uₘ, the observed viewing behavior of members for a job k y_{v,m,k}, and the observed application behavior of users for the job k y_{a,m,k}. The interaction component 220 is configured to identify sets of interactions for members with the member's profile uₘ and the profile-based fields j_{p,k} to determine observed viewing behavior of users for the job 127 k y_{v,m,k}, and the observed application behavior of users for the job 127 k y_{a,m,k}. The interaction component 220, alone or in combination with the vector component 230, compares fields of a member profile (as indicated in the member's profile uₘ) interacting with the kth job 127 to profile-based fields j_{p,k}, in accordance with some embodiments. For example, the interaction component 220 may identify first attributes which are common to the member profile and the profile-based fields and second attributes of the member profile which are excluded from the profile-based fields. Further, the interaction component 220 may identify third attributes which are common among member profiles which interacted with the job profile at a similar action level (e.g., a first-level interaction) but are excluded from the profile-based fields. For the observed application behavior of users for the job 127 k y_{a,m,k}, the interaction component 220 compares fields of the profile-based fields j_{p,k} with the member's profile uₘ to determine first attributes which are common to the member profile and the profile-based fields. The interaction component 220 also compares fields of member profiles interacting with (e.g., applying to) the job profile at the same level of interaction to determine attributes common among the member profiles and excluded from the profile-based fields.

In some embodiments, the interaction component 220 compares all of the fields of a member profile or set of member profiles (as indicated in the member's profile uₘ) interacting with the kth job 127 with profile-based fields j_{p,k} and member profiles of members interacting with jobs 127 determined to be similar to the profile-based fields j_{p,k}. The interaction component 220 determines a score of closeness (e.g., a similarity score), in accordance with some embodiments. In some embodiments, the interaction component 220 builds a dictionary of synonyms that it uses to compare the fields and interaction levels. The dictionary of synonyms is built by determining relationships of words occurring in one or more of member profiles, job profiles, entity profiles, and categorical relationships (e.g., associations or hierarchical relationships) of the social networking system 100. For example, the interaction component 220 may determine a synonym relationship between two words where multiple member profiles or job profiles use one or both of the words interchangeably. By way of further example, the interaction component 220 may determine a synonym or other relationship between a first word and a second word where a portion of member profiles uses a first word and a portion of member profiles uses a second word, and the first word and the second word are determined to refer to a single concept, entity, or item. The dictionary of synonyms may also incorporate established semantic relationships (e.g., relationships indicated in a dictionary or thesaurus). In these embodiments, the dictionary of synonyms is generated as a data structure indicating relationships among words and groups of words (e.g., clusters of related words). In some instances, the interaction component 220 builds a hierarchy and ranking of terms to use to compare fields, e.g., information technology may be ranked as being closer to developer than salesperson, and interaction levels. In some example embodiments, the interaction component 220 determines one or more first job profiles that are similar to a second job profile of the social network system 100 by comparing one or more fields of the one or more first job profiles with the second job profile and determining a score for how closely the one or more fields match with fields of the second job profile. The interaction component 220 then identifies interactions and interaction levels for members interacting with the one or more second job profiles determined to be similar to the first job profile to provide data to the vector component 230 for generating or tuning the vector model for the first job profile.

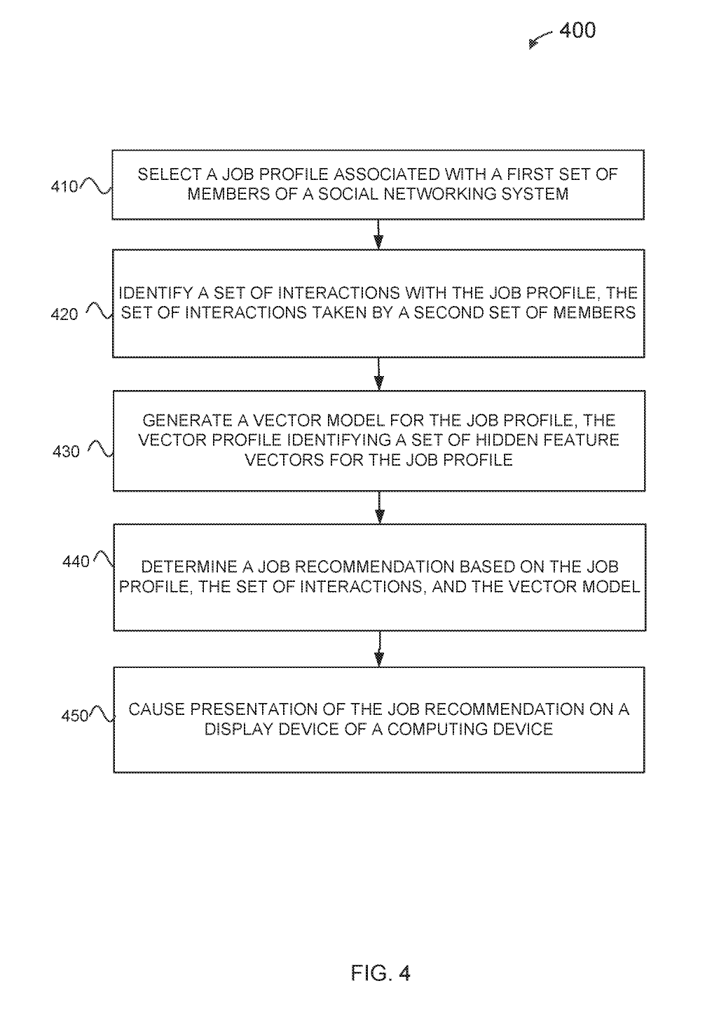

FIG. 4 illustrates a method 400 for generating job recommendations using hidden feature vectors and a generated vector model, in accordance with some embodiments. The operations of method 400 may be performed by components of the job recommendation engine 112, and are so described below for purposes of illustration.

In operation 410, the access component 210 selects a job profile. The job profile is associated with a first set of members of a social networking system 100. The job profile comprises a set of attributes. As described above, the attributes may include a set of fields including data relating to the job profile. In some instances, the attributes comprise relevant skills, duties, education, certifications, locations, industries, companies, or other characteristics, qualifications, or information relating to the job profile. In some embodiments, the access component 210 selects the job profile from a set of job profiles stored within the social network system 100. The job profile may be stored within the profile data 120 and accessible by the access component 210 within the social network system 100 or via a network connection. In some embodiments, the access component 210 selects the job profile based on input from a member of the social network system 100. For example, the member from which the input is received may be one of the first set of members associated with the job profile. In these instances, the member of the social network system 100 causes a user device to transmit a user interface selection, to one or more of the access component 210 and the interface component 250, indicating a request for the job recommendation engine 112. In some embodiments, the request is a request for a job recommendation. In some instances, the request is generated after receiving an indication that the member is interested in a job. For example, where the member selects a user interface element representing a job search or jobs of potential interest, one or more of the access component 210 and the interface component 250 receives the selection and causes the access component 210 to select the first job profile.

In operation 420, the interaction component 220 identifies a set of interactions with the job profile. The set of interactions comprises actions taken by a second set of members of the social networking system 100 with respect to the job profile. In some embodiments, the set of interactions comprise multiple levels of interactions. Each level of interactions may be associated with a distinct level or type of actions. In some example embodiments, the set of interactions comprise at least a set of first-level interactions and a set of second-level interactions. The set of first-level interactions are associated with a first action type. The set of second-level interactions are associated with a second action type. In some instances, the set of first-level interactions are taken or performed by a first portion of members of the second set of members and the set of second-level interactions are taken or performed by a second portion of members of the second set of members. In some embodiments, the second portion of the second set of members comprise at least a portion of the first set of members associated with the job profile.

In operation 430, the vector component 230 generates a vector model for the job profile. The vector model may be based on the set of attributes of the job profile, the set of interactions, and the second set of members (e.g., attributes of member profiles associated with the second set of members). The vector model identifies a set of hidden feature vectors for the first job profile. In some instances, the set of hidden feature vectors for the job profile are elements common to the first set of members and the second set of members. As hidden feature vectors, the common elements are excluded from the job profile. In some embodiments, the vector component 230 generates the vector model for the job profile using equations (1a), (1b), (1c), (1d), (2a), and (2b). Equations (1a), (1b), (1c), and (1d) may be performed by a first sub-component of the vector component 230 and equations (2a) and (2b) may be performed by a second sub-component of the vector component 230. In some instances, the first sub-component and the second sub-component operate contemporaneously or nearly contemporaneously. As will be explained in more detail below, convergence of values generated by the first sub-component and the second sub-component generates and fits the vector model.

In some example embodiments, operation 430 is performed using a set of sub-operations. The set of sub-operations comprises determining first regression coefficients and a first hidden feature vector. In example embodiments including sets of first-level interactions and second-level interactions, the first regression coefficients and the first hidden feature vector are determined for the set of first-level interactions. In some embodiments, the first regression coefficients and the first hidden feature vector are determined jointly for the set of member interactions. In some instances, the first regression coefficients comprise a vector coefficient and a variance coefficient. The vector coefficient indicates a similarity of a first portion of members of the second set of members with the job profile. The variance coefficient controls a variance of a distribution from which the first hidden feature vector is selected.

In some embodiments, the sub-operations of operation 430 comprise the vector component 230 determining second regression coefficients and a second hidden feature vector. In example embodiments including sets of first-level interactions and second-level interactions, the second regression coefficients and the second hidden feature vector are determined for the set of second-level interactions. In some embodiments, the second regression coefficients and the second hidden feature vector are determined jointly for the second set of members. In some instances, the second regression coefficients comprise a vector coefficient and a variance coefficient. The vector coefficient indicates a similarity of the second portion of members of the second set of members to the job profile. The variance coefficient controls a variance of a distribution from which the second hidden feature vector is selected.

Although described separately, in some embodiments, the vector component 230 performs the sub-operations for determining the first regression coefficients and the first hidden feature vector and the sub-operations for determining the second regression coefficients and the second hidden feature vector as a single set of sub-operations for performing operation 430. Further, in some embodiments, the vector component 230 determines the first regression coefficients and the first hidden feature vector jointly for the first set of members and determines the second regression coefficients and the second hidden feature vector jointly for the second set of members in a single set of sub-operations for performing operation 430.

As referenced above, in embodiments using a first sub-component and a second sub-component of the vector component 230, the first sub-component generates the first regression coefficients and the second regression coefficients. The second sub-component generates (e.g., identifies) the first hidden feature vector and the second hidden feature vector.

In operation 440, the recommendation component 240 determines a job recommendation based on the job profile, the set of interactions, the second set of members, and the vector model for the job profile. In some instances, the recommendation component 240 determines the job recommendation based on the above-referenced elements and a specified member profile of the social networking system 100. Provided the specified member profile, the recommendation component 240 accesses a set of job profiles. Each job profile of the set of job profiles is associated with a vector model, a first hidden feature vector, and a second hidden feature vector. In some example embodiments, the recommendation component 240 receives the first hidden feature vector and the second hidden feature vector, of each job profile, from the respective vector model. The recommendation component 240 compares the specified member profile to the first and second hidden feature vectors of the set of job profiles within the social network system 100. In some instances, the job profile selected in operation 410 is included in the set of job profiles. Upon identifying attributes associated with the specified member profile as matching at least a portion of the first and second hidden feature vectors within or associated with one or more job profiles of the set of job profiles, the recommendation component 240 selects the one or more job profiles as a recommendation set. The one or more job profiles selected for inclusion in the recommendation set may include the job profile selected in operation 410 where at least a portion of the feature vectors determined for the job profile match attributes in the specified member profile. In some instances, the recommendation component 240 orders the recommendation set for presentation at a computing device of a selected member. In some example embodiments, the recommendation component 240 selects a portion of the recommendation set for presentation at the computing device of the selected member.

In operation 450, the interface component 250 causes presentation of the job recommendation on a display device communicatively coupled to a hardware processor of a computing device associated with the selected member. In some instances, the interface component 250 causes presentation of the job recommendation (e.g., one or more job profiles of the recommendation set) on the display device by transmitting the set of job profiles or a representation thereof for incorporation and display within a user interface presented on the display device. In some instances, the interface component 250 causes presentation of the job recommendation by generating a user interface screen or one or more user interface elements for inclusion in an existing user interface screen. The interface component 250 causes transmission of the user interface screen or the one or more user interface elements. Receipt of the user interface screen or the one or more user interface elements causes the computing device of the selected member to render and display the user interface screen or one or more user interface elements on the display device.

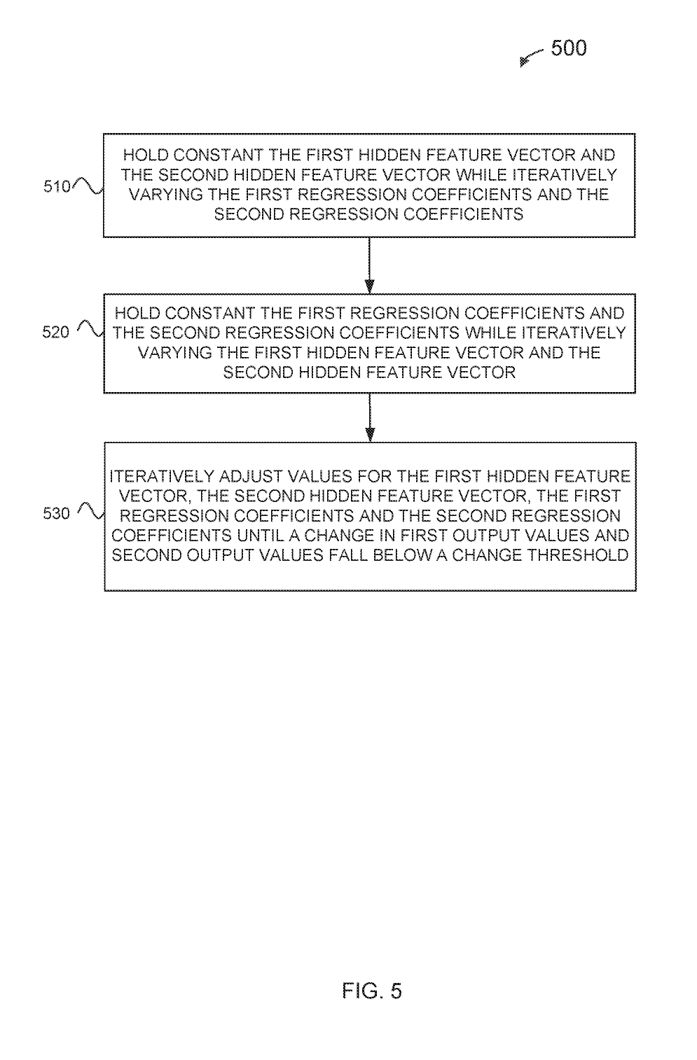

FIG. 5 illustrates a method 500 of determining regression coefficients and a hidden feature vector of a hierarchical structure, in accordance with some embodiments. The operations of method 500 may be performed by components of the job recommendation engine 112. In some instances, certain operations of the method 500 may be performed using one or more operations of the method 400 or as sub-operations of one or more operations of the method 400, as will be explained in more detail below.

In operation 510, the vector component 230 holds constant the first hidden feature vector and the second hidden feature vector while iteratively varying the first regression coefficients and the second regression coefficients. In some embodiments, the vector component 230 iterates values of the first regression coefficients and the second regression coefficients in equations (1a), (1b), (1c), and (1d) during operation 510. In instances, where the vector component 230 comprises the first sub-component and the second sub-component, the first sub-component cooperates to iterate the first regression coefficients and the second regression coefficients while the second sub-component holds constant the values for the first hidden feature vector and the second hidden feature vector. In some instances, the vector component 230 tracks the values resulting from iterations of the first regression coefficients and the second regression coefficients to generate a regression value set.

In operation 520, the vector component 230 holds constant the first regression coefficients and the second regression coefficients while iteratively varying the first hidden feature vector and the second hidden feature vector. In some embodiments, the vector component 230 iterates values of the first hidden feature vector and the second hidden feature vector in equations (2a) and (2b) during operation 520. In instances where the vector component 230 comprises the first sub-component and the second sub-component, the second sub-component cooperates to iterate the first hidden feature vector and the second hidden feature vector while the first sub-component holds constant the values for the first regression coefficients and the second regression coefficients. In some instances, the vector component 230 tracks the values resulting from iterations of the first hidden feature vector and the second hidden feature vector to generate a feature value set.

In operation 530, the vector component 230 iteratively adjusts values for the first hidden feature vector, the second hidden feature vector, the first regression coefficients, and the second regression coefficients until a change in first output values (e.g., the regression value set) and second output values (e.g., the feature value set) fall below a change threshold. The first output values are generated from iteratively adjusting the first hidden feature and the second hidden feature vector, as described above with respect to operation 510. The second output values are generated from iteratively adjusting the first regression coefficients and the second regression coefficients, as described above with respect to operation 520. In some embodiments, the vector component 230 iteratively adjusts the first hidden feature vector, the second hidden feature vector, the first regression coefficients, and the second regression coefficients according to a Bayesian method, deriving an expectation maximization from iterative adjustment of the values. The expectation maximization may be based on a determined approximate solution indicated by a convergence of the output values (e.g., the change between the output values falling below the change threshold). In some instances, maximizing the likelihood of p(D|ϕ) is equivalent to maximizing the log likelihood, L(D|ϕ)=ln p(D|ϕ).

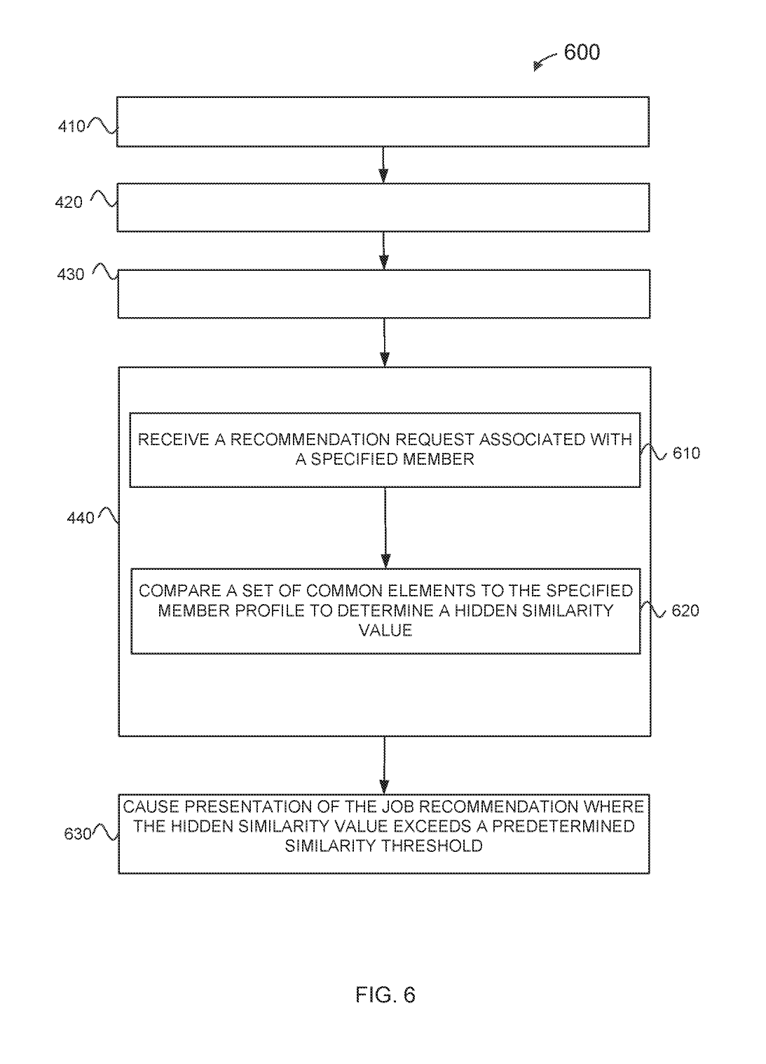

FIG. 6 illustrates a method 600 of determining regression coefficients and hidden feature vectors using a machine learning model, in accordance with some embodiments. The method 600 may be performed, at least in part, by the job recommendation engine 112 or components thereof. In some embodiments, the method 600 includes one or more operations of the method 400 or 500. In some instances, one or more operations of the method 600 are performed as parts or sub-operations of one or more operations of the method 400 or 500. For example, as shown in FIG. 6, at least a portion of the operations of method 600 are performed as sub-operations or parts of operation 440 of method 400.

In operation 610, the interface component 250 receives a recommendation request. The recommendation request is associated with a specified member profile of the social networking system 100. As discussed above, the specified member profile comprises a set of attributes. The attributes may include fields populated with data representing skills, employment history, industry information, education history, certifications, demographic information, and any other suitable information identifying the specified member or characteristics and qualifications thereof. The recommendation request may be generated and transmitted to the interface component 250 upon selection of a designated user interface element for a job recommendation. In some embodiments, the recommendation request is automatically triggered upon an action of the specified member. In these embodiments, the action triggering the recommendation request comprises one or more of a job search, an indication that the specified user is interested in a job recommendation, a change to an attribute of the specified member profile (e.g., a change in job title or inclusion of a closing date of a term of employment with a current employer), selection of job announcements (e.g., clicking or saving job announcements), applying to a job or otherwise responding to a job announcement, entering job search terms, or any other suitable action.

In operation 620, the recommendation component 240 compares a set of common elements to the specified member profile to determine a hidden similarity value. In some embodiments, the first hidden feature vector comprises a first set of common elements for a first portion of members of the second set of members associated with the set of first-level interactions. The second hidden feature vector comprises a second set of common elements for a second portion of members of the second set of members associated with the set of second-level interactions. The first set of common elements and the second set of common elements are excluded from the job profile, in these embodiments. The hidden similarity value may represent a similarity between the set of common elements and the attributes listed within the specified member profile. In some instances, the hidden similarity value is determined as a percentage of attributes included in the specified member profile which are also included in the set of common elements. The hidden similarity value may also be determined as a ratio of common elements, a semantic distance, a Hamming distance, or any other value indicating a similarity between the set of common elements and the attributes of the specified member profile. In some embodiments, the hidden similarity value is determined as a match (e.g., a synonym relationship) between element or aspects occurring in two or more job profiles. The match may be determined as an exact match, a relative match representing a synonym relationship linking the elements as indicated by the dictionary of synonyms, or any other suitable match.

In operation 630, the interface component 250 causes presentation of the job recommendation where the hidden similarity value exceeds a predetermined similarity threshold. In some embodiments, the interface component 250 presents the job recommendation in a manner similar to or the same as the manner described with respect to operation 450. In some embodiments, the interface component 250 causes presentation of the job recommendation comprising a single job 127. The interface component 250 may also present the job recommendation comprising a plurality of jobs 127. In these instances, operations 610 and 620 may be performed for a plurality of job profiles. Job profiles associated with hidden similarity values exceeding a predetermined threshold may be presented within the job recommendation. In some instances, where the job recommendation comprises a plurality of job profiles, the job profiles are ordered according to their respective hidden similarity values.

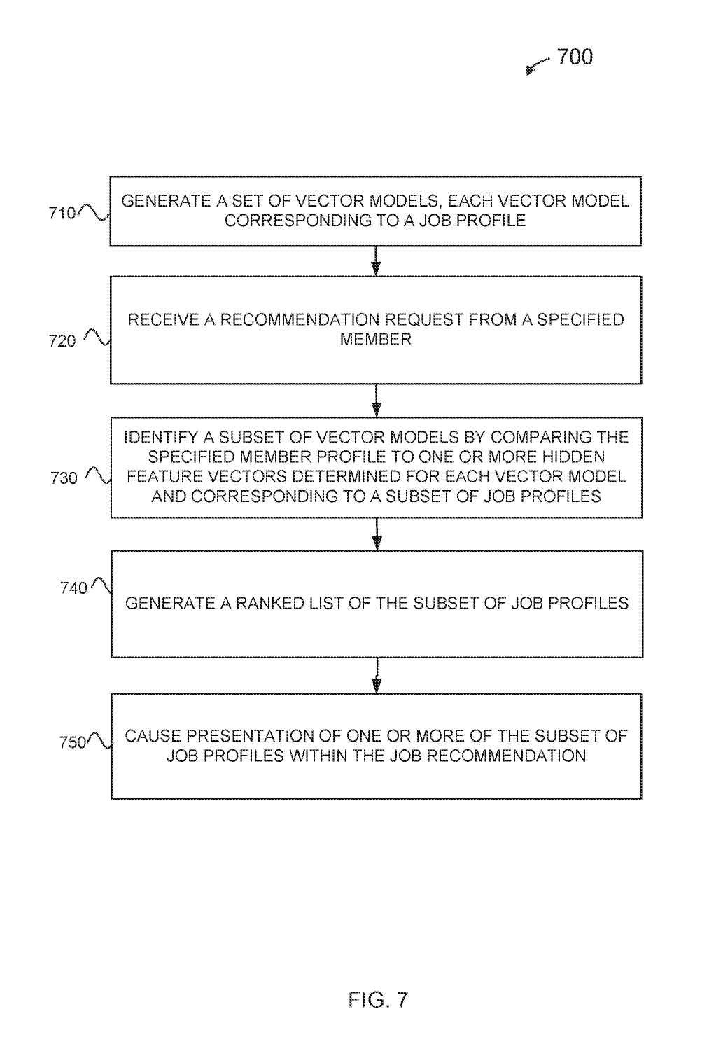

FIG. 7 illustrates a method 700 of determining regression coefficients and a hidden feature vector of a hierarchical structure, in accordance with some embodiments. The method 700 may be performed, at least in part, by the job recommendation engine 112 or components thereof. In some embodiments, the method 700 includes one or more operations of the method 400, 500, or 600. In some instances, one or more operations of the method 700 are performed as parts or sub-operations of one or more operations of the method 400, 500, or 600.

In operation 710, the vector component 230 generates a set of vector models within the social networking system 100. Each vector model of the set of vector models corresponds to a different job profile of the social networking system 100. The vector models generate outputs comprising at least one set of hidden feature vectors for each job profile. In some embodiments, the vector component 230 periodically updates, regenerates, tunes, or otherwise adjusts the set of vector models. A vector model of the set of vector models may be updated periodically, based on an interaction metric, upon changes to associated member profiles exceeding a change threshold, or according to any other suitable timeframe or metric. In some instances, the interaction metric indicates a number of members of the social networking system 100 who interacted with a job profile associated with a specified vector model. In some instances, the interaction metric represents a combined interaction for all levels of interactions or action types. In some instances, the interaction metric includes individual values for each type or level of interaction (e.g., viewing a job profile, applying to a job profile, sharking a job profile, or liking a job profile). Updating based on the interaction metric may be triggered after a number of members of the social networking system 100, exceeding a member threshold, interact with the job profile. In some embodiments, the changes to associated member profiles comprise changes to attributes (e.g., skills, experience, etc.) without changing an interaction with the job profile. In these instances, where a number of members, exceeding a member threshold, make similar changes to their respective member profiles, without overriding or modifying the interaction with the job profile, the vector component 230 updates the vector model for the specified job profile.

In operation 720, the interface component 250 receives a recommendation request from the specified member. In some example embodiments, the interface component 250 receives the recommendation request from a computing device associated with the specified member. The association between the device and the member may be based on a log in to the social networking system 100 from the computing device using credentials of the specified member, based on a device identification for the computing device, or any other suitable basis. In some embodiments, the computing device receives selection of a user interface element indicating the recommendation request. The user interface element may be associated with a recommendation request, associated with a job search option (e.g., tab, link, or button), or any other indication that the specified user is interested in a job recommendation. For example, as described above, in cooperation with the application server modules 110, the interface component 250 may receive a portion of the behavior data 124. The portion of the behavior data 124 may include a change to an attribute of a member profile (e.g., a change in job title or inclusion of a closing date of a term of employment with a current employer), selection of job announcements (e.g., clicking or saving job announcements), applying to a job or otherwise responding to a job announcement, or entering job search terms. Upon receiving selection of the user interface element, the computing device transmits the recommendation request to the interface component 250. The interface component 250 passes an indication of the recommendation request to one or more components of the job recommendation engine 112. In some instances, the interface component 250 causes the vector component 230 to initiate operations to identify vector models matching the specified member profile of the specified member.

In operation 730, the vector component 230 identifies a subset of vector models of the set of vector models by comparing the specified member profile to one or more hidden feature vectors determined for each vector model of the set of vector models. The subset of vector models corresponds to a subset of job profiles on the social networking system 100. In some embodiments, the vector component 230 identifies the subset of vector models using hidden similarity values similar to the manner described above with respect to operation 620. In some instances, the vector component 230 parses the hidden feature vectors for each model, identifying vector models having one or more hidden feature vector matching an attribute of the specified member profile for the specified member. The vector component 230 identifies vector models, and associated job profiles, having a number of matching hidden feature vectors exceeding a match threshold.

In operation 740, the recommendation component 240 generates a ranked list of the subset of job profiles. The ranked list of the subset of job profiles corresponds to the subset of vector models identified in operation 730. The ranked list corresponds to an order for the subset of vector models determined by the recommendation component 240. In some embodiments, the recommendation component 240 receives identifications for job profiles associated with each vector model of the subset of vector models. The recommendation component 240 also receives an indication of a relative similarity of the vector model to the specified member profile of the specified member (e.g., hidden similarity value or number of matching attributes). The recommendation component 240 generates an order for the job profiles based on the indication of the relative similarities of the vector models to generate the ranked list. The recommendation component 240 then passes the ranked list to the interface component 250.

In operation 750, the interface component 250 causes presentation of one or more of the subset of job profiles within the job recommendation. In embodiments where two or more of the subset of job profiles are presented, the two or more job profiles are presented according to the respective positions of each job profile within the ranked list generated in operation 740. In some instances, the interface component 250 causes presentation of the ranked list, or one or more job profiles from the ranked list, within the job recommendation in a manner similar to or the same as described above with respect to operation 450 or operation 630.

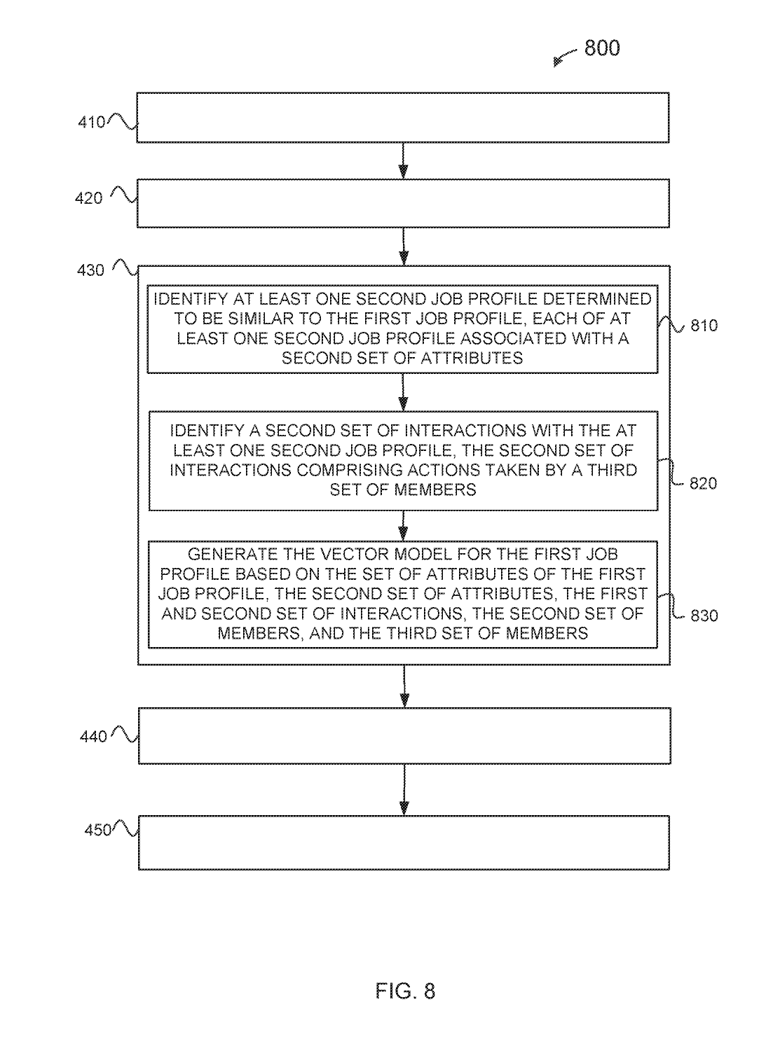

FIG. 8 illustrates a method 800 of determining regression coefficients and a hidden feature vector of a hierarchical structure, in accordance with some embodiments. The method 800 may be performed, at least in part, by the job recommendation engine 112 or components thereof. In some embodiments, the method 800 includes one or more operations of the method 400, 500, 600, or 700. In some instances, one or more operations of the method 800 are performed as parts or sub-operations of one or more operations of the method 400, 500, 600, or 700. In some embodiments, the job profile, for which the vector model is generated and described above, is a first job profile and the set of interactions, described above, is a first set of interactions with the first job profile. In these embodiments, the operations of the method 800 are performed as part of or sub-operations of generating a vector model. In some instances, the operations of the method 800 are performed as part of operation 430, described above.

In operation 810, the vector component 230 identifies at least one second job profile. The vector component 230, alone or in combination with one or more other components of the job recommendation engine 112, identifies the at least one second job profile by accessing a set of job profiles. The vector component 230 identifies one or more of a job profile, a vector model, and a set of hidden feature vectors for each job profile of the set of job profiles. The vector component 230 compares the attributes of the set of job profiles to the first job profile to determine the at least one second job profile similar to the first job profile. The attributes compared to the first job profile include a second set of attributes associated with the at least one second job profile. In some instances, the vector component 230 compares vector models and sets of hidden feature vectors of the set of job profiles to the first job profile. Similarity between the first job profile and the at least one second job profile may be determined by matching attributes or fields of the first job profile and the at least one second job profile, determining semantic distances between attributes or data included in the first job profile and the at least one second job profile, or any other suitable manner.

In operation 820, the vector component 230 identifies a second set of interactions with the at least one second job profile. The second set of interactions comprising actions taken by a third set of members of the social networking system 100 with respect to the at least one second job profile. In some instances, the vector component 230 cooperates with the interaction component 220 to identify the second set of interactions in a manner similar to or the same as that described above with respect to operation 420.

In operation 830, the vector component 230 generates the vector model for the first job profile based on the set of attributes of the first job profile, the second set of attributes, the first set of interactions, the second set of interactions, the second set of members, and the third set of members. In some embodiments, the vector component 230 generates the vector model in a manner similar to or the same as operation 430, described above. In these instances, the vector component 230 generates the vector model by additionally incorporating information associated with the at least one second job profile (e.g., the second set of attributes, the second set of interactions, and the third set of members) into equations (1a), (1b), (1c), (1d), (2a), and (2b). The output of combining the above-referenced equations with data from the first job profile and the at least one second job profile produces a first hidden feature vector and a second hidden feature vector representing member profile attributes common to members viewing, applying, or otherwise interacting with similarly situated and described job profiles, even though the member profile attributes are excluded from the similarly situated job profiles.

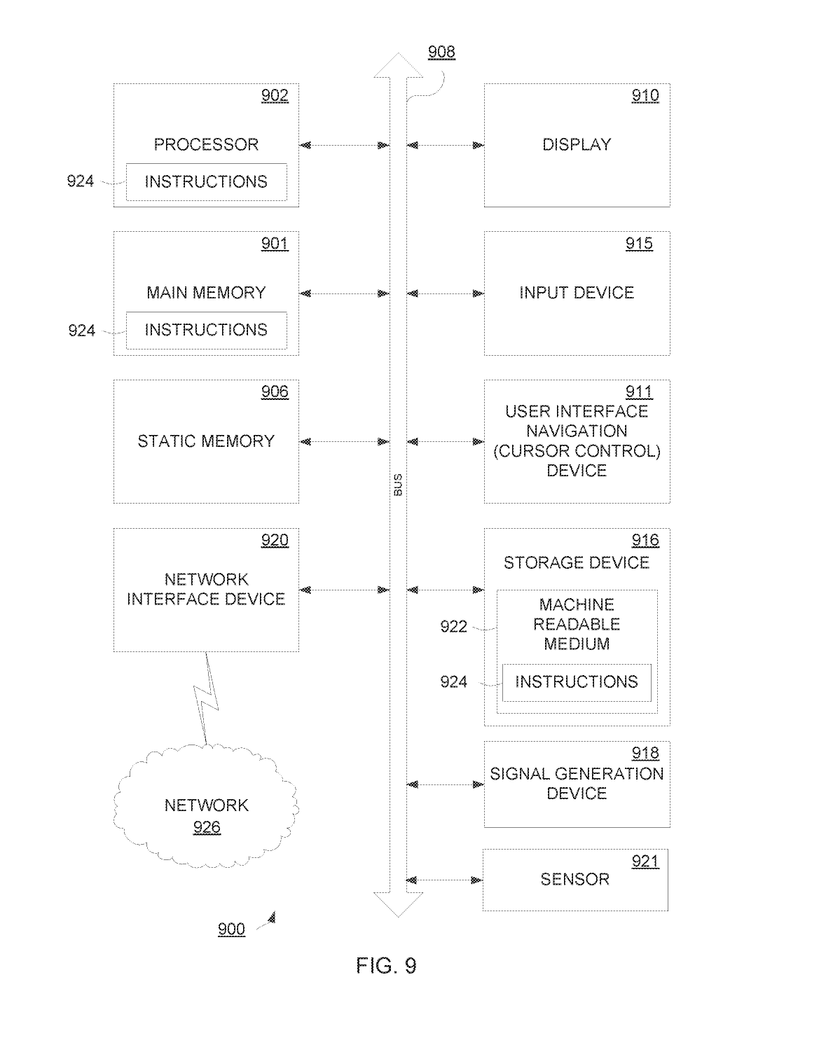

FIG. 9 shows a diagrammatic representation of the machine 900 in the example form of a computer system and within which instructions 924 (e.g., software) for causing the machine 900 to perform any one or more of the methodologies discussed herein may be executed. In alternative embodiments, the machine 900 operates as a standalone device or may be connected (e.g., networked) to other machines. In a networked deployment, the machine 900 may operate in the capacity of a server machine or a client machine in a server-client network environment, or as a peer machine in a peer-to-peer (or distributed) network environment. The machine 900 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine 900 capable of executing the instructions 924, sequentially or otherwise, that specify actions to be taken by that machine. Further, while only a single machine 900 is illustrated, the term “machine” shall also be taken to include a collection of machines that individually or jointly execute the instructions 924 to perform any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 901, and a static memory 906, which are configured to communicate with each other via a bus 908. The machine 900 may further include a graphics display 910 (e.g., a plasma display panel (PDP), a light emitting diode (LED) display, a liquid crystal display (LCD), a projector, or a cathode ray tube (CRT)). The machine 900 may also include an alphanumeric input device 915 (e.g., a keyboard), a cursor control device 914 (e.g., a mouse, a touchpad, a trackball, a joystick, a motion sensor, or other pointing instrument), a storage unit 916, a signal generation device 918 (e.g., a speaker), and a network interface device 920.

The storage unit 916 includes a machine-readable medium 922 on which is stored the instructions 924 (e.g., software) embodying any one or more of the methodologies or functions described herein. The instructions 924 may also reside, completely or at least partially, within the main memory 904, within the processor 902 (e.g., within the processor's cache memory), or both, during execution thereof by the machine 900. Accordingly, the main memory 904 and the processor 902 may be considered as machine-readable media 922. The instructions 924 may be transmitted or received over a network 926 via the network interface device 920.

As used herein, the term “memory” refers to a machine-readable medium 922 able to store data temporarily or permanently and may be taken to include, but not be limited to, random-access memory (RAM), read-only memory (ROM), buffer memory, flash memory, and cache memory. While the machine-readable medium 922 is shown in an example embodiment to be a single medium, the term “machine-readable medium” should be taken to include a single medium or multiple media (e.g., a centralized or distributed database, or associated caches and servers) able to store instructions 924. The term “machine-readable medium” shall also be taken to include any medium, or combination of multiple media, that is capable of storing instructions 924 (e.g., software) for execution by a machine (e.g., machine 900), such that the instructions 924, when executed by one or more processors of the machine 900 (e.g., processor 902), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium 922 or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 902 or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 902 or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor 902 configured by software to become a special-purpose processor, the general-purpose processor 902 may be configured as respectively different special-purpose processors (e.g., comprising different hardware modules) at different times. Software may accordingly configure a processor 902, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 902 that are temporarily configured (e.g., by software) or permanently configured to perform the relevant operations. Whether temporarily or permanently configured, such processors 902 may constitute processor-implemented modules that operate to perform one or more operations or functions described herein. As used herein, “processor-implemented module” refers to a hardware module implemented using one or more processors 902.

Similarly, the methods described herein may be at least partially processor-implemented, a processor 902 being an example of hardware. For example, at least some of the operations of a method may be performed by one or more processors 902 or processor-implemented modules. Moreover, the one or more processors 902 may also operate to support performance of the relevant operations in a “cloud computing” environment or as a “software as a service” (SaaS). For example, at least some of the operations may be performed by a group of computers (as examples of machines 900 including processors 902), with these operations being accessible via a network 926 (e.g., the Internet) and via one or more appropriate interfaces (e.g., an application program interface (API)).

The performance of certain of the operations may be distributed among the one or more processors 902, not only residing within a single machine 900, but deployed across a number of machines. In some example embodiments, the one or more processors 902 or processor-implemented modules may be located in a single geographic location (e.g., within a home environment, an office environment, or a server farm). In other example embodiments, the one or more processors 902 or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine 900 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine 900. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Although embodiments have been described with reference to specific examples, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The following examples pertain to further embodiments and combinations of the above-described embodiments. Specifics in the examples may be used in one or more embodiments. To better illustrate the apparatus and methods disclosed herein, a non-limiting list of examples is provided here:

1. A method of generating a job recommendation, the method including: selecting, by at least one hardware processor 902, a job profile, the job profile associated with a first set of members of a social networking system 100, the job profile comprising a set of attributes; identifying, by at the least one hardware processor 902, a set of interactions with the job profile, the set of interactions comprising actions taken by a second set of members of the social networking system 100 with respect to the job profile; generating, by the at least one hardware processor 902, a vector model for the job profile based on the set of attributes of the job profile, the set of interactions, and the second set of members, the vector model identifying a set of hidden feature vectors for the job profile; determining, by the at least one hardware processor 902, a job recommendation based on the job profile, the set of interactions, the set of second members, and the vector model; and causing presentation of the job recommendation on a display device 910 communicatively coupled to a hardware processor 902 of a computing device.

2. The method of example 1, wherein the set of interactions of the second set of members comprises a set of first-level interactions associated with a first action type and a set of second-level interactions associated with a second action type, the set of first-level interactions taken by a first portion of members of the second set of members and the set of second-level interactions taken by a second portion of members of the second set of members, the second portion of the second set of members comprising at least a portion of the first set of members.

3. The method of examples 1 or 2, wherein generating the vector model further comprises determining first regression coefficients and a first hidden feature vector jointly for at least a portion of the set of interactions; and determining second regression coefficients and a second hidden feature vector jointly for at least a portion of the set of interactions.

4. The method of any one or more of examples 1-3, wherein the set of interactions comprises a set of first-level interactions associated with a first action type and a set of second-level interactions associated with a second action type, the first regression coefficients and the first hidden feature vector being determined for the set of first-level interactions, and the second regression coefficients and the second hidden feature vector being determined for the set of second-level interactions.

5. The method of any one or more of examples 1-4, wherein the first regression coefficients comprise a vector coefficient and a variance coefficient, the vector coefficient indicating a similarity of a first portion of members of the second set of members associated with the set of first-level interactions and the variance coefficient controlling a variance of a distribution from which the first hidden feature vector is selected.

6. The method of any one or more of examples 1-5, wherein the second regression coefficients comprise a vector coefficient and a variance coefficient, the vector coefficient indicating a similarity of a second portion of members of the second set of members associated with the set of second-level interactions and the variance coefficient controlling a variance of a distribution from which the second hidden feature vector is selected.

7. The method of any one or more of examples 1-6, wherein generating the vector model further comprises holding constant the first hidden feature vector and the second hidden feature vector while iteratively varying the first regression coefficients and the second regression coefficients; holding constant the first regression coefficients and the second regression coefficients while iteratively varying the first hidden feature vector and the second hidden feature vector; and iteratively adjusting values for the first hidden feature vector, the second hidden feature vector, the first regression coefficients, and the second regression coefficients until a change in first output values and second output values fall below a change threshold, the first output values generated from iteratively adjusting the first hidden feature vector and the second hidden feature vector, the second output values generated from iteratively adjusting the first regression coefficients and the second regression coefficients.

8. The method of any one or more of examples 1-7, wherein the first hidden feature vector comprises a first set of common elements for a first portion of members of the second set of members associated with the set of first-level interactions and excluded from the job profile, and the second hidden feature vector comprises a second set of common elements for a second portion of members of the second set of members associated with the set of second-level interactions and excluded from the job profile, and wherein determining the job recommendation further comprises receiving, by the at least one hardware processor 902, a recommendation request associated with a specified member profile of the social networking system 100, the specified member profile comprising a set of attributes; comparing, by the at least one hardware processor 902, the first set of common elements and the second set of common elements to the set of attributes of the specified member profile to determine a hidden similarity value; and causing presentation of the job recommendation where the hidden similarity value exceeds a predetermined similarity threshold.

9. The method of any one or more of examples 1-8, further comprising generating a set of vector models within the social networking system 100, each vector model of the set of vector models corresponding to a different job profile of the social networking system 100; receiving a recommendation request from a specified member, the specified member associated with a specified member profile; identifying a subset of vector models of the set of vector models by comparing the specified member profile to one or more hidden feature vectors determined for each vector model of the set of vector models, the subset of vector models corresponding to a subset of job profiles on the social networking system 100; generating a ranked list of the subset of job profiles corresponding to the identified subset of vector models; and causing presentation of one or more of the subset of job profiles within the job recommendation.

10. The method of any one or more of examples 1-9, wherein the job profile is a first job profile and the set of interactions is a first set of interactions with the first job profile, and generating the vector model further comprises identifying at least one second job profile, the at least one second job profile determined to be similar to the first job profile, each of the at least one second job profile comprising a second set of attributes; identifying a second set of interactions with the at least one second job profile, the second set of interactions comprising actions taken by a third set of members of the social networking system 100 with respect to the at least one second job profile; and generating the vector model for the first job profile based on the set of attributes of the first job profile, the second set of attributes, the first set of interactions, the second set of interactions, the second set of members, and the third set of members.

11. A system comprising one or more processors 902; and a processor-readable storage device comprising processor executable instructions 924 that, when executed by the one or more processors 902, causes the one or more processors 902 to perform operations comprising: selecting, by the one or more processors 902, a job profile, the job profile associated with a first set of members of a social networking system 100, the job profile comprising a set of attributes; identifying, by the one or more processors 902, a set of interactions with the job profile, the set of interactions comprising actions taken by a second set of members of the social networking system 100 with respect to the job profile; generating, by the one or more processors 902, a vector model for the job profile based on the set of attributes of the job profile, the set of interactions, and the second set of members, the vector model identifying a set of hidden feature vectors for the job profile; determining, by the one or more processors 902, a job recommendation based on the job profile, the set of interactions, the set of second members, and the vector model; and causing presentation of the job recommendation on a display device 910 communicatively coupled to a hardware processor 902 of a computing device.

12. The system of example 11 wherein generating the vector model further comprises determining first regression coefficients and a first hidden feature vector jointly for at least a portion of the set of interactions; and determining second regression coefficients and a second hidden feature vector jointly for at least a portion of the set of interactions.

13. The system of examples 11 or 12 wherein generating the vector model further comprises holding constant the first hidden feature vector and the second hidden feature vector while iteratively varying the first regression coefficients and the second regression coefficients; holding constant the first regression coefficients and the second regression coefficients while iteratively varying the first hidden feature vector and the second hidden feature vector; and iteratively adjusting values for the first hidden feature vector, the second hidden feature vector, the first regression coefficients, and the second regression coefficients until a change in first output values and second output values fall below a change threshold, the first output values generated from iteratively adjusting the first hidden feature vector and the second hidden feature vector, the second output values generated from iteratively adjusting the first regression coefficients and the second regression coefficients.

14. The system of any one or more of examples 10-13, wherein the first hidden feature vector comprises a first set of common elements for a first portion of members of the second set of members associated with the set of first-level interactions and excluded from the job profile, and the second hidden feature vector comprises a second set of common elements for a second portion of members of the second set of members associated with the set of second-level interactions and excluded from the job profile, and wherein determining the job recommendation further comprises receiving, by the at least one hardware processor 902, a recommendation request associated with a specified member profile of the social networking system 100, the specified member profile comprising a set of attributes; comparing, by the at least one hardware processor 902, the first set of common elements and the second set of common elements to the set of attributes of the specified member profile to determine a hidden similarity value; and causing presentation of the job recommendation where the hidden similarity value exceeds a predetermined similarity threshold.

15. The system of any one or more of examples 10-14, wherein the operations further comprise generating a set of vector models within the social networking system 100, each vector model of the set of vector models corresponding to a different job profile of the social networking system 100; receiving a recommendation request from a specified member, the specified member associated with a specified member profile; identifying a subset of vector models of the set of vector models by comparing the specified member profile to one or more hidden feature vectors determined for each vector model of the set of vector models, the subset of vector models corresponding to a subset of job profiles on the social networking system 100; generating a ranked list of the subset of job profiles corresponding to the identified subset of vector models; and causing presentation of one or more of the subset of job profiles within the job recommendation.

16. A processor-readable storage device 916 comprising processor executable instructions 924 that, when executed by one or more processors 902 of a machine 900, causes the machine 900 to perform operations comprising selecting, by the one or more processors 902, a job profile, the job profile associated with a first set of members of a social networking system 100, the job profile comprising a set of attributes; identifying, by the one or more processors 902, a set of interactions with the job profile, the set of interactions comprising actions taken by a second set of members of the social networking system 100 with respect to the job profile; generating, by the one or more processors 902, a vector model for the job profile based on the set of attributes of the job profile, the set of interactions, and the second set of members, the vector model identifying a set of hidden feature vectors for the job profile; determining, by the one or more processors 902, a job recommendation based on the job profile, the set of interactions, the set of second members, and the vector model; and causing presentation of the job recommendation on a display device 910 communicatively coupled to a hardware processor 902 of a computing device.

17. The processor-readable storage device 916 of example 16, wherein generating the vector model further comprises determining first regression coefficients and a first hidden feature vector jointly for at least a portion of the set of interactions; and determining second regression coefficients and a second hidden feature vector jointly for at least a portion of the set of interactions.

18. The processor-readable storage device of examples 16 or 17, wherein generating the vector model further comprises holding constant the first hidden feature vector and the second hidden feature vector while iteratively varying the first regression coefficients and the second regression coefficients; holding constant the first regression coefficients and the second regression coefficients while iteratively varying the first hidden feature vector and the second hidden feature vector; and iteratively adjusting values for the first hidden feature vector, the second hidden feature vector, the first regression coefficients, and the second regression coefficients until a change in first output values and second output values fall below a change threshold, the first output values generated from iteratively adjusting the first hidden feature vector and the second hidden feature vector, the second output values generated from iteratively adjusting the first regression coefficients and the second regression coefficients.

19. The processor-readable storage device 916 of any one or more of examples 16-18, wherein the first hidden feature vector comprises a first set of common elements for a first portion of members of the second set of members associated with the set of first-level interactions and excluded from the job profile, and the second hidden feature vector comprises a second set of common elements for a second portion of members of the second set of members associated with the set of second-level interactions and excluded from the job profile, and wherein determining the job recommendation further comprises receiving, by the at least one hardware processor 902, a recommendation request associated with a specified member profile of the social networking system 100, the specified member profile comprising a set of attributes; comparing, by the at least one hardware processor 902, the first set of common elements and the second set of common elements to the set of attributes of the specified member profile to determine a hidden similarity value; and causing presentation of the job recommendation where the hidden similarity value exceeds a predetermined similarity threshold.

20. The processor-readable storage device 916 of any one or more of examples 16-19, wherein the operations further comprise generating a set of vector models within the social networking system 100, each vector model of the set of vector models corresponding to a different job profile of the social networking system 100; receiving a recommendation request from a specified member, the specified member associated with a specified member profile; identifying a subset of vector models of the set of vector models by comparing the specified member profile to one or more hidden feature vectors determined for each vector model of the set of vector models, the subset of vector models corresponding to a subset of job profiles on the social networking system 100; generating a ranked list of the subset of job profiles corresponding to the identified subset of vector models; and causing presentation of one or more of the subset of job profiles within the job recommendation.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method of generating a job recommendation, the method comprising:
selecting, by at least one hardware processor, a job profile, the job profile associated with a first set of members of a social networking system, the job profile comprising a set of attributes;
identifying, by the at least one hardware processor, a set of interactions with the job profile, the set of interactions comprising actions taken by a second set of members of the social networking system with respect to the job profile;
generating, by the at least one hardware processor, a vector model for the job profile based on the set of attributes of the job profile, the set of interactions, and the second set of members, the vector model identifying a set of hidden feature vectors for the job profile;
determining, by the at least one hardware processor, a job recommendation based on the job profile, the set of interactions, the set of second members, and the vector model; and
causing presentation of the job recommendation on a display device communicatively coupled to a hardware processor of a computing device.

2. The method of claim 1, wherein the set of interactions of the second set of members comprises a set of first-level interactions associated with a first action type and a set of second-level interactions associated with a second action type, the set of first-level interactions taken by a first portion of members of the second set of members and the set of second-level interactions taken by a second portion of members of the second set of members, the second portion of the second set of members comprising at least a portion of the first set of members.

3. The method of claim 1, wherein generating the vector model further comprises:
determining first regression coefficients and a first hidden feature vector jointly for at least a portion of the set of interactions, and
determining second regression coefficients and a second hidden feature vector jointly for at least a portion of the set of interactions.

4. The method of claim 3, wherein the set of interactions comprises a set of first-level interactions associated with a first action type and a set of second-level interactions associated with a second action type, the first regression coefficients and the first hidden feature vector being determined for the set of first-level interactions, and the second regression coefficients and the second hidden feature vector being determined for the set of second-level interactions.

5. The method of claim 4, wherein the first regression coefficients comprise a vector coefficient and a variance coefficient, the vector coefficient indicating a similarity of a first portion of members of the second set of members associated with the set of first-level interactions and the variance coefficient controlling a variance of a distribution from which the first hidden feature vector is selected.

6. The method of claim 4, wherein the second regression coefficients comprise a vector coefficient and a variance coefficient, the vector coefficient indicating a similarity of a second portion of members of the second set of members associated with the set of second-level interactions and the variance coefficient controlling a variance of a distribution from which the second hidden feature vector is selected.

7. The method of claim 4, wherein the first hidden feature vector comprises a first set of common elements for a first portion of members of the second set of members associated with the set of first-level interactions and excluded from the job profile, and the second hidden feature vector comprises a second set of common elements for a second portion of members of the second set of members associated with the set of second-level interactions and excluded from the job profile, and wherein determining the job recommendation further comprises:
receiving, by the at least one hardware processor, a recommendation request associated with a specified member profile of the social networking system, the specified member profile comprising a set of attributes;
comparing, by the at least one hardware processor, the first set of common elements and the second set of common elements to the set of attributes of the specified member profile to determine a hidden similarity value; and
causing presentation of the job recommendation where the hidden similarity value exceeds a predetermined similarity threshold.

8. The method of claim 3, wherein generating the vector model further comprises:
holding constant the first hidden feature vector and the second hidden feature vector while iteratively varying the first regression coefficients and the second regression coefficients;
holding constant the first regression coefficients and the second regression coefficients while iteratively varying the first hidden feature vector and the second hidden feature vector; and
iteratively adjusting values for the first hidden feature vector, the second hidden feature vector, the first regression coefficients, and the second regression coefficients until a change in first output values and second output values fall below a change threshold, the first output values generated from iteratively adjusting the first hidden feature vector and the second hidden feature vector, the second output values generated from iteratively adjusting the first regression coefficients and the second regression coefficients.

9. The method of claim 1, further comprising:
generating a set of vector models within the social networking system, each vector model of the set of vector models corresponding to a different job profile of the social networking system;
receiving a recommendation request from a specified member, the specified member associated with a specified member profile;
identifying a subset of vector models of the set of vector models by comparing the specified member profile to one or more hidden feature vectors determined for each vector model of the set of vector models, the subset of vector models corresponding to a subset of job profiles on the social networking system;
generating a ranked list of the subset of job profiles corresponding to the identified subset of vector models; and
causing presentation of one or more of the subset of job profiles within the job recommendation.

10. The method of claim 1, wherein the job profile is a first job profile and the set of interactions is a first set of interactions with the first job profile, and generating the vector model further comprises:
identifying at least one second job profile, the at least one second job profile determined to be similar to the first job profile, each of the at least one second job profile comprising a second set of attributes;
identifying a second set of interactions with the at least one second job profile, the second set of interactions comprising actions taken by a third set of members of the social networking system with respect to the at least one second job profile; and
generating the vector model for the first job profile based on the set of attributes of the first job profile, the second set of attributes, the first set of interactions, the second set of interactions, the second set of members, and the third set of members.

11. A system comprising:
one or more processors; and
a processor-readable storage device comprising processor executable instructions that, when executed by the one or more processors, causes the one or more processors to perform operations comprising
selecting, by the one or more processors, a job profile, the job profile associated with a first set of members of a social networking system, the job profile comprising a set of attributes;
identifying, by the one or more processors, a set of interactions with the job profile, the set of interactions comprising actions taken by a second set of members of the social networking system with respect to the job profile;
generating, by the one or more processors, a vector model for the job profile based on the set of attributes of the job profile, the set of interactions, and the second set of members, the vector model identifying a set of hidden feature vectors for the job profile;
determining, by the one or more processors, a job recommendation based on the job profile, the set of interactions, the set of second members, and the vector model; and
causing presentation of the job recommendation on a display device communicatively coupled to a hardware processor of a computing device.

12. The system of claim 11, wherein generating the vector model further comprises:
determining first regression coefficients and a first hidden feature vector jointly for at least a portion of the set of interactions; and
determining second regression coefficients and a second hidden feature vector jointly for at least a portion of the set of interactions.

13. The system of claim 12, wherein generating the vector model further comprises:
holding constant the first hidden feature vector and the second hidden feature vector while iteratively varying the first regression coefficients and the second regression coefficients;
holding constant the first regression coefficients and the second regression coefficients while iteratively varying the first hidden feature vector and the second hidden feature vector; and
iteratively adjusting values for the first hidden feature vector, the second hidden feature vector, the first regression coefficients, and the second regression coefficients until a change in first output values and second output values falls below a change threshold, the first output values generated from iteratively adjusting the first hidden feature vector and the second hidden feature vector, the second output values generated from iteratively adjusting the first regression coefficients and the second regression coefficients.

14. The system of claim 12, wherein the first hidden feature vector comprises a first set of common elements for a first portion of members of the second set of members associated with a set of first-level interactions and excluded from the job profile, and the second hidden feature vector comprises a second set of common elements for a second portion of members of the second set of members associated with a set of second-level interactions and excluded from the job profile, and wherein determining the job recommendation further comprises:
receiving, by the one or more processors, a recommendation request associated with a specified member profile of the social networking system, the specified member profile comprising a set of attributes,
comparing, by the one or more processors, the first set of common elements and the second set of common elements to the set of attributes of the specified member profile to determine a hidden similarity value; and
causing presentation of the job recommendation where the hidden similarity value exceeds a predetermined similarity threshold.

15. The system of claim 11, wherein the operations further comprise:
generating a set of vector models within the social networking system, each vector model of the set of vector models corresponding to a different job profile of the social networking system;
receiving a recommendation request from a specified member, the specified member associated with a specified member profile;
identifying a subset of vector models of the set of vector models by comparing the specified member profile to one or more hidden feature vectors determined for each vector model of the set of vector models, the subset of vector models corresponding to a subset of job profiles on the social networking system;
generating a ranked list of the subset of job profiles corresponding to the identified subset of vector models; and
causing presentation of one or more of the subset of job profiles within the job recommendation.

16. A processor-readable storage device comprising processor executable instructions that, when executed by one or more processors of a machine, causes the machine to perform operations comprising:
selecting, by the one or more processors, a job profile, the job profile associated with a first set of members of a social networking system, the job profile comprising a set of attributes;
identifying, by the one or more processors, a set of interactions with the job profile, the set of interactions comprising actions taken by a second set of members of the social networking system with respect to the job profile;
generating, by the one or more processors, a vector model for the job profile based on the set of attributes of the job profile, the set of interactions, and the second set of members, the vector model identifying a set of hidden feature vectors for the job profile;
determining, by the one or more processors, a job recommendation based on the job profile, the set of interactions, the set of second members, and the vector model; and
causing presentation of the job recommendation on a display device communicatively coupled to a hardware processor of a computing device.

17. The processor-readable storage device of claim 16, wherein generating the vector model further comprises:
determining first regression coefficients and a first hidden feature vector jointly for at least a portion of the set of interactions; and
determining second regression coefficients and a second hidden feature vector jointly for at least a portion of the set of interactions.

18. The processor-readable storage device of claim 17, wherein generating the vector model further comprises:
holding constant the first hidden feature vector and the second hidden feature vector while iteratively varying the first regression coefficients and the second regression coefficients;
holding constant the first regression coefficients and the second regression coefficients while iteratively varying the first hidden feature vector and the second hidden feature vector; and
iteratively adjusting values for the first hidden feature vector, the second hidden feature vector, the first regression coefficients, and the second regression coefficients until a change in first output values and second output values fall below a change threshold, the first output values generated from iteratively adjusting the first hidden feature vector and the second hidden feature vector, the second output values generated from iteratively adjusting the first regression coefficients and the second regression coefficients.

19. The processor-readable storage device of claim 17, wherein the first hidden feature vector comprises a first set of common elements for a first portion of members of the second set of members associated with a set of first-level interactions and excluded from the job profile, and the second hidden feature vector comprises a second set of common elements for a second portion of members of the second set of members associated with a set of second-level interactions and excluded from the job profile, and wherein determining the job recommendation further comprises:
receiving, by the one or more processors, a recommendation request associated with a specified member profile of the social networking system, the specified member profile comprising a set of attributes,
comparing, by the one or more processors, the first set of common elements and the second set of common elements to the set of attributes of the specified member profile to determine a hidden similarity value; and
causing presentation of the job recommendation where the hidden similarity value exceeds a predetermined similarity threshold.

20. The processor-readable storage device of claim 16, wherein the operations further comprise:
generating a set of vector models within the social networking system, each vector model of the set of vector models corresponding to a different job profile of the social networking system;
receiving a recommendation request from a specified member, the specified member associated with a specified member profile;
identifying a subset of vector models of the set of vector models by comparing the specified member profile to one or more hidden feature vectors determined for each vector model of the set of vector models, the subset of vector models corresponding to a subset of job profiles on the social networking system;
generating a ranked list of the subset of job profiles corresponding to the identified subset of vector models; and
causing presentation of one or more of the subset of job profiles within the job recommendation.
